(19) United States
(12) Patent Application Publication
(10) Pub. No.: US 2025/0083425 A1
(43) Pub. Date: Mar. 13, 2025

(54) A MULTI-LAYER FLEXIBLE PACKAGING MATERIAL

(71) Applicant: SOCIETE DES PRODUITS NESTLE S.A., Vevey (CH)

(72) Inventor: KIRIL DIMITROV, York Yorkshire (GB)

(21) Appl. No.: 18/580,244

(22) PCT Filed: Jul. 19, 2022
(86) PCT No.: PCT/EP2022/070265

§ 371 Date: Jan. 18, 2024

(30) Foreign Application Priority Data
Jul. 20, 2021 (EP) 21186706.4
Dec. 10, 2021 (EP) 21213776.4

(51) Int. Cl. B32B 27/10; B32B 27/16; B32B 27/32; D21H 19/08; D21H 19/22; D21H 19/54; D21H 19/82; D21H 21/16; D21H 27/10

(52) U.S. Cl. CPC B32B 27/10; B32B 27/16; B32B 27/32; D21H 19/08; D21H 19/22; D21H 19/54; D21H 19/82; D21H 21/16; D21H 27/10; B32B 2250/02; B32B 2255/10; B32B 2255/12; B32B 2255/205; B32B 2255/28; B32B 2307/31; B32B 2307/4023; B32B 2307/718; B32B 2307/7244; B32B 2307/7246; B32B 2307/728; B32B 2307/7376; B32B 2439/70

(57) ABSTRACT

The present invention relates generally to the field of multi-layer flexible packaging material. In particularly, the present invention relates to a multi-layer flexible packaging material to package dry food, preferably confectionery.

### FIELD OF THE INVENTION

The present invention relates generally to the field of multi-layer flexible packaging material. In particularly, the present invention relates to a multi-layer flexible packaging material. The present invention further relates to the use of the multi-layer flexible packaging material in accordance with the present invention to package dry food.

### BACKGROUND OF THE INVENTION

Plastic packaging is used frequently in the economy and in people's daily lives. It has multiple advantages, such as its flexibility and its light weight. Such a weight reduction contributes to lower demand on material resources, as well as fuel saving and CO2 reduction during transport, for example. Its barrier properties help to reduce food waste due a positive effect on increasing shelf life. The barrier properties also help to secure food safety.

However, according to the European strategy for plastics in a circular economy, recently published by the European Commission, around 25.8 million tons of plastic waste are generated in Europe every year with less than 30% of such waste being collected for recycling and between 150 000 to 500 000 tons of plastic waste entering the oceans every year.

To ensure that plastic waste is reduced, significant efforts are made in the industry and in commerce. Several supermarkets replace plastic bags by paper based bags, for example. However, replacing plastics with paper in food packaging is not an easy task. A change in packaging material must not compromise consumer safety. The packaging must serve to protect the food during distribution, storage and retail, but must also be robust enough to be handled by machines during the production process, and must allow that the food product is presented effectively.

Hence, there is a need for renewable and effectively recycled cost effective materials with improved barrier properties. There is—in particular—a need for paper based packaging materials with improved barrier properties, as in addition to their partial or full renewability they can also be effectively recycled in the existing and well established paper recycling infrastructure.

WO 2000/076862 describes in this respect a laminate structure for packaging applications comprising a paper substrate; and at least one polymer/nanoclay composite layer having clay particles with a thickness ranging from 0.7 to 9 nanometres applied to said paper substrate.

However, there is a need in the art to even further improve the barrier properties of a paper based packaging material.

In particular, for packaging intended for food products, good barrier properties are essential for maintaining the safety and quality of packaged foods. Typically, such barrier properties include gas permeability, for example O2, CO2, and N2; vapor permeability, for example water vapor; liquid permeability, for example water or oil; aroma permeability; and light permeability.

In addition, against this background of recycling, is the issue of packaging not being appropriately disposed of by the consumer, i.e. littering. Such material may end up in the natural environment. Traditional confectionery packaging is also small, which increases the likelihood of accidental littering and the plastic materials used can take years to disintegrate.

Hence, the present invention seeks to balance the issues of barrier properties and recyclability.

Any reference to prior art documents in this specification is not to be considered an admission that such prior art is widely known or forms part of the common general knowledge in the field.

### SUMMARY OF THE INVENTION

The objective of the present invention is to improve the state of the art and, in particular, to provide a multi-layer flexible packaging material that provides improved barrier properties and may be recycled; and to provide the use of such a multi-layer flexible packaging material to package dry food products, or to at least to provide a useful alternative to packaging solutions existing in the art.

The present inventors have solved the above problems by preparing a multi-layer flexible packaging material comprising the following layers from the outer surface to the inner surface:
a paper layer with a grammage of from 40 to 120 g/m2,
an optional hydrophilic layer with a grammage of at least 1.5 g/m2,
a barrier layer comprising a metallized material, aluminium oxide or silicon oxide or mixtures thereof with a thickness in the range of from 20 to 300 nm, and
a polymeric layer with a grammage of from 1.0 to 15.0 g/m2,
wherein said polymeric layer comprises at least one plastic polymer.

The present invention provides water vapor transmission rate (WVTR) and oxygen transmission rate (OTR) test results that satisfied the requirements for the packaging of dry food materials, as well as offering recycling opportunities.

Consequently, the objective of the present invention was achieved by the subject matter of the independent claims. The dependent claims further develop the concept of the present invention.

The present invention further provides a use of a multi-layer flexible packaging material in accordance with the present invention to package dry food, preferably confectionery, preferably a chocolate product, cereal and/or nut-based bar, and/or biscuit or wafer product.

As used in this specification, the words “comprises”, “comprising”, and similar words, are not to be interpreted in an exclusive or exhaustive sense. In other words, they are intended to mean “including, but not limited to”.

### BRIEF DESCRIPTION OF THE DRAWINGS

FIG. 1. Schematic of the present invention

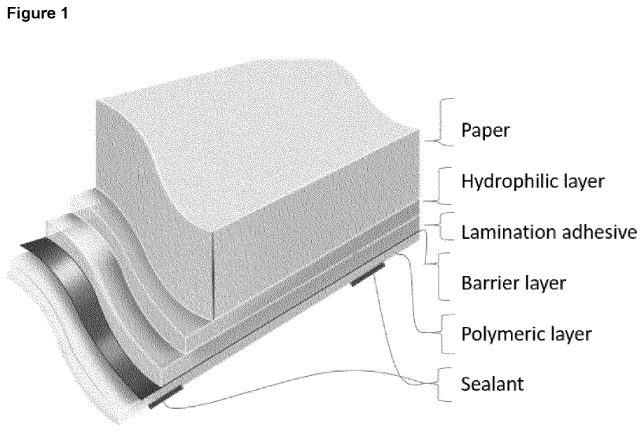

### DETAILED DESCRIPTION OF THE INVENTION

The present invention relates to a multi-layer flexible packaging material comprising the following layers from the outer surface to the inner surface:
a paper layer with a grammage of from 40 to 120 g/m2,
an optional hydrophilic layer with a grammage of at least 1.5 g/m2,
a barrier layer comprising a metallized material, aluminium oxide or silicon oxide or mixtures thereof with a thickness in the range of from 20 to 300 nm, and
a polymeric layer with a grammage of from 1.0 to 15.0 g/m2,
wherein said polymeric layer comprises at least one plastic polymer.

In an alternative embodiment, the order of the barrier layer and polymeric layer is reversed from the outer to the inner surface.

For the purposes of the present invention, a packaging material shall be considered flexible if it is a material capable of bending without breaking. Further, for example, such a flexible material may be a material that can be bent without breaking by hand. Preferably, a multi-layer flexible packaging material in accordance with the present invention may have a basis weight of 140 g/m2 or less, more preferably of 120 g/m2 or less, more preferably of 100 g/m2 or less and less than 90 g/m2 or 80 g/m2.

The packaging material of the present invention is paper-based. People skilled in the art will be able to select an appropriate paper layer, for example, based on the product to be packaged, and in particular its size & weight, packing process, the distribution channel(s), requirements for graphics & communication and whether the paper material is to be used as primary, secondary, or tertiary packaging.

In a preferred embodiment, ink is applied to the outer surface of the paper layer, the outer layer of the paper is uncoated, the outer layer is surface sized or the outer layer is pigment coated. These surface treatments of the paper may be carried out by known methods in the art.

The present invention comprises barrier layer comprising a metallized material, aluminium oxide or silicon oxide or mixtures thereof. In a preferred embodiment, the mixtures thereof comprise individual layers of the materials.

The metallisation layer may be applied to a polymeric film by physical vapor deposition. For example, the metallisation layer may be applied by means of a vacuum deposition process. An example of a vacuum deposition process is described in Thin Solid Films, Volume 666, 30 November 2018, Pages 6-14. Vacuum deposition is an evaporative process in which a metal forms a solid phase is transferred to the vapor phase and back to the solid phase, gradually building up film thickness. Coatings produced by vacuum deposition have the advantage of good abrasion resistance, impact and temperature strength, as well as the capability to be deposited on complex surfaces. In a preferred embodiment, the metallisation deposits aluminium.

In a preferred embodiment, the combination of polymeric film and barrier layer has a total thickness of between 5.0 and 12.0 microns, preferably between 6.0 and 10.0 microns, preferably between 7.0 and 9.5 microns and preferably between 7.5 and 8.5 microns.

In the present invention, the method of deposition of the aluminium oxide and silicon dioxide film is not limited. Silicon dioxide films can be produced by different methods, such as sol-gel, liquid phase deposition, sputtering, Chemical Vapor Deposition (CVD), thermal oxidation, Plasma Enhanced Chemical Vapor Deposition (PECVD), atmospheric pressure plasma deposition, and Physical Vapor Deposition (PVD). PVD is one of the most established vacuum deposition techniques. It includes vacuum evaporation, ion plating and sputtering deposition. These techniques allow better control of the film thickness and they ensure that the deposited film has a good adhesion performance.

In the present invention, the method of deposition of the aluminium oxide film is not limited. In an embodiment, the aluminium oxide layer may be deposited by vacuum deposition.

A person skilled in the art may adjust the thickness of the barrier layer appropriately, for example, depending on the intended shelf life, the packaged product and the overall thickness of the packaging material. In the multi-layer flexible packaging material in accordance with present invention, the barrier layer may have a thickness in the range of 20-300 nm, 30-275 nm, or 50-200nm, for example.

The range of optical density for the barrier layer may preferably be in the range of 1.4-3.8 and more preferably 1.4-3.5, which correlates with a thickness of 30-200 nanometres.

In a preferred embodiment, the polymeric layer comprises a polyolefin or polyester. Preferably, the polymeric layer comprises a polymer selected from the group consisting of polyethylene, polypropylene, polyethylene terephthalate, polyhydroxyalkanoates, polylactic acid and copolymers thereof and mixtures thereof. In a preferred embodiment, the polymeric layer comprises polypropylene.

In a highly preferred embodiment, the polymeric layer is oriented, for example, biaxially oriented.

In a highly preferred embodiment, the polymeric is an oriented polyolefin or oriented polyethylene terephthalate, preferably an oriented polypropylene (OPP).

In a highly preferred embodiment, the polymeric is an extruded layer. These extrusion production methods are well known in the art. For example, an oriented film (e.g. OPP) is obtained by calendering a layer of molten polymer to obtain a film and processing it to obtain an orientation of the molecules.

In a preferred embodiment, the polymeric layer is not produced by a dispersion coating technique.

By using the features of the present invention in combination, it is possible to achieve the necessary barrier properties in combination with recyclability and using commercially available materials without the need for more complicated production processes, such as dispersion coating.

In a preferred embodiment, the paper layer has a grammage of from 40 to 120 g/m2, preferably from 50 to 100 g/m2 and more preferably or 60 to 90 g/m2 or 50 to 80 g/m2.

In a preferred embodiment, the polymeric layer has a grammage in the range of from 1.5 to 12.0 g/m2, preferably from 3.0 to 10.0 g/m2 and more preferably from 4.0 to 8.0 g/m2. In a highly preferred embodiment, the upper limit is 8.0 g/m2.

In a preferred embodiment, the hydrophilic layer has a grammage in the range of from 1.5 to 10.0 g/m2, preferably from 2.0 to 8.0 g/m2 and more preferably from 3.0 to 6.0 g/m2.

In a preferred embodiment, the total grammage of the packaging is in the range of from 42.5 to 140 g/m2, preferably from 50 to 120 g/m2, and more preferably from 60 to 100 g/m2 or 60 to 90 g/m2.

In a preferred embodiment, the paper layer has a grammage of from 60 to 90 g/m2,
the hydrophilic layer has a grammage in the range of from 1.5 to 6.0 g/m2.
the barrier layer comprises a metallized material, and
the polymeric layer has a grammage in the range of from 1.0 to 8.0 g/m2.

In a preferred embodiment, the multi-layer flexible packaging material further comprises a lamination adhesive layer between the paper layer or hydrophilic layer (if present) and barrier layer, preferably the adhesive layer has a grammage not exceeding 3.5g/m2, preferably between 0.5 g/m2 to 3.5 g/m2.

Appropriate lamination adhesives are known to the person skilled in the art and can be selected accordingly. The lamination adhesive to be applied between the paper layer/hydrophilic layer on the paper layer and the barrier layer may be polyurethane.

The general polyurethane adhesive contains some sort of a polyol or mixtures, and some sort of an isocyanate or mixtures. Other extenders and alternate cross-linking chemistry may also be present.

The multi-layer flexible packaging material of the present invention may be a packaging material for a food product. It may be a primary packaging material, a secondary packaging material or a tertiary packaging material, for example. If the multi-layer flexible packaging material is a packaging material for a food product, a primary packaging material for a food product may be a packaging material for a food product that is in direct contact with the actual food product. A secondary packaging material for a food product may be a packaging material for a food product that helps secure one or more food products contained in a primary packaging. Secondary packaging material is typically used when multiple food products are provided to consumers in a single container. A tertiary packaging material for a food product may be a packaging material for a food product that helps secure one or more food products contained in a primary packaging and/or in a primary and secondary packaging during transport.

In order to utilise the laminate of the present invention as a commercial material containing foodstuffs the following features may preferably be present. The structure may be printed over the pigment coated or uncoated paper surface with suitable for the process and the specific surface inks with the desired graphical artwork. Cold seal or heat seal may be applied using a specific pattern to register over the polymer side to enable flow wrapping applications. Release lacquer may be applied over the printed surface to ensure cold seal does not permanently adhere to the printed surface when reeled for delivery to a packing site. The structure may be used on horizontal or vertical flow wrapping machines for packaging foodstuffs as required.

In a preferred embodiment, the packaging is a primary packaging for a food product, preferably a confectionery food product, preferably a chocolate product, cereal and/or nut bar, and/or biscuit or wafer product.

In a preferred embodiment, the hydrophilic layer may comprise or consist of starch, pigment-starch or a pigment-latex formulation. The ratio of pore volume to total volume of the paper material is called the porosity of the paper material. For the purpose of the present invention, a paper layer shall be considered as non-porous if a Gurley permeability is less than 20 ml/min (Tappi T547), if it has a porosity of less than 40%, for example, less than 30% or less than 20%. Hence, in one embodiment of the present invention, the paper layer is a non-porous paper layer.

It may also be preferred if the paper layer has a low surface roughness. For example, the paper layer may have a Bendtsen roughness of less than 100 ml/min. The Bendtsen roughness can be determined in accordance with ISO 8791-2:2013, herewith incorporated herein by reference.

Barrier properties of packaging materials are well known to the person skilled in the art. If the packaging material is a packaging material for a food product, for example, such good barrier properties are essential for maintaining the safety and quality of packaged foods. Typically, such barrier properties include gas permeability, for example O2, CO2, and N2; vapor permeability, for example water vapor; liquid permeability, for example water or oil; aroma permeability; and light permeability.

To ensure that the barrier layer is well protected against abrasion, for example, it may be protected with a protection layer. Appropriate protection layers are well-known to the person skilled in the art and may be selected from the group consisting of acrylic acid copolymers, polyesters, polyhydroxyalkanoates, native and chemically modified starches, xylan and chemically modified xylan, polyvinylidene dichloride, polyvinyl alcohol, ethyl-vinyl alcohol, vinyl acetate, ethyl-vinyl acetates, cellulose nitrate, polyolefins, silanes, polyurethanes, or combinations thereof. Using such protection layers has the advantage that the aluminium layer is stabilized and well protected against unfavourable influences, maintaining its integrity and—hence—its positive influence on the barrier properties of the multi-layer flexible packaging material of the present invention.

Coating paper materials, such as paper packaging materials, with a sealing layer, for example, with polymer dispersions, e.g., to improve the barrier properties of the paper material, is well known in the art. Examples are, for example described in Kimpimäki T., Savolainen A. V. (1997) Barrier dispersion coating of paper and board. In: Brander J., Thorn I. (eds) Surface Application of Paper Chemicals. Springer, Dordrecht. coated, paper materials.

For consumer information and design purposes an ink layer may be applied onto the paper layer. Also here it may be preferred, if there is a primer applied between paper layer and ink layer. Appropriate primers are known to the person skilled in the art, and may, for example, be a polyurethane primer.

In order to add a high quality finishing to the outer surface of the multi-layer flexible packaging material in accordance with the present invention an overprint varnish (OPV) may be applied to the surface of the ink layer. OPV are well-known to the person skilled in the art and may be chosen, e.g., according to the intended purpose of the packaging material of the present invention. For example, the OPV may be selected from the group consisting of conventional offset letterpress varnishes, acrylic varnishes, UV varnishes, and gravure varnishes which can be represented by water or solvent-based polymer formulations.

Thus, the multi-layer flexible packaging material of the present invention may further comprise a primer applied to the paper layer, an ink layer applied to the primer on the paper layer, and an overprint varnish layer applied to the ink layer.

The multi-layer flexible packaging material in accordance with the present invention may have any thickness suitable for packaging materials. A person skilled in the art will be able to determine an appropriate thickness. Typically, however, in particular if the packaging material is intended for use in packaging food products, the packaging material should be as thin as possible, while still ensuring safety and shelf life of the food product. For example, the multi-layer flexible packaging material in accordance with the present invention may have an overall thickness in the range of 30-150 μm, 40-120 μm, or 50-100 μm.

A person skilled in the art may select the grammages or thicknesses of the individual components of the multi-layer flexible packaging material in accordance with the present invention appropriately.

In a preferred embodiment, the plastic layer is produced by extrusion. In a preferred embodiment, the plastic layer is surfaced treated using a corona (air plasma) process.

In a preferred embodiment, the present invention provides a method of producing the material of the present invention comprising the steps of:
Extruding, a preferably orientated or subsequently orientating, a plastic layer,
The plastic layer is Corona surface treated,
A barrier layer is applied using physical vapour deposition,
A paper layer optionally has a hydrophilic layer applied,
An adhesive layer is applied onto the paper layer or hydrophilic layer (if present), and
The metallised film is laminated to the adhesive layer.

The extrusion, Corona surface treatment, physical vapour deposition, hydrophilic and adhesive layers application and lamination may be carried out by the methods described above and/or those known in the art.

In a preferred embodiment of the present invention, the multi-layer flexible packaging material in accordance with the present invention may be recyclable. For example, it may be recyclable with the paper and carton stream. During recycling, the metallised polymer layer will be separated from the rest of the packaging. Typically, metallised polymer is separated from the rest of the packaging material during recycling in a hydra-pulper. The low level of plastic material and potentially choice of plastic material assist in the recycling. Hence, the multi-layer flexible packaging material in accordance with the present invention may be recyclable as paper and/or carton.

These excellent barrier properties allow it that the multi-layer flexible packaging material in accordance with the present invention may be used to package food products. For the purpose of the present invention, the term “food” shall mean in accordance with Codex Alimentarius any substance, whether processed, semi-processed or raw, which is intended for human consumption, and includes drink, chewing gum and any substance which has been used in the manufacture, preparation or treatment of “food” but does not include cosmetics or tobacco or substances used only as drugs.

Remarkably, the excellent barrier properties allow it that the multi-layer flexible packaging material in accordance with the present invention may be used to package dry food products. Dry food products include powders and granulates, for example powders and granulates to be reconstituted in milk or in water. Dry food products may have a water content of 5% or less, for example.

Hence, the multi-layer flexible packaging material in accordance with the present invention may be to be used to package dry food. The subject matter of the present invention also extends to the use of a multi-layer flexible packaging material in accordance with the present invention to package dry food.

Those skilled in the art will understand that they can freely combine all features of the present invention disclosed herein. In particular, features described for the product of the present invention may be combined with features described for the process of the present invention and vice versa. Further, features described for different embodiments of the present invention may be combined.

Although the invention has been described by way of example, it should be appreciated that variations and modifications may be made without departing from the scope of the invention as defined in the claims.

Furthermore, where known equivalents exist to specific features, such equivalents are incorporated as if specifically referred in this specification.

### EXAMPLES

The following structures were prepared as follows:

### Example 1

1) Release lacquer full coverage applied in a gravure process
2) 2 colour design gravure printed
3) Uncoated bleached kraft paper 70 gsm, 91 microns
4) 1 component solventless lamination adhesive 3.5 gsm
5) Vacuum deposited aluminium barrier layer with OD (optical density) of 2.1
6) 8 micron OPP Corona treated film (7.1gsm)
7) Cold seal adhesive applied in pattern in a gravure process

### Example 2

1) Release lacquer full coverage applied in a gravure process
2) 2 colour design gravure printed
3) Uncoated bleached kraft paper 65 gsm with a 10 gsm hydrophilic layer consisting of starch, pigment and binder, total of 75 gsm/95 micron
4) 1 component solventless lamination adhesive 3.5 gsm applied over the hydrophilic layer
5) Vacuum deposited aluminium barrier layer with OD (optical density) of 2.1
6) 8 micron OPP Corona treated film (7.1 gsm)
7 Cold seal adhesive applied in pattern in a gravure process

The following tests were carried out on the materials specified below.

TABLE 1
Metallised OPP Barrier film layer

| Property | Test method | Units | Measurement |
|---|---|---|---|
| Thickness | ISO 4591 | micron | 7.75 |
| Density | DIN EN ISO 1183 | g/cm³ | 0.91 |
| OD | Tobias TBX transmission | | 2.91-2.99 |
| | densitometer | | |

TABLE 2
Paper structures

| | | | 70 gsm | 65 gsm Paper + |
|---|---|---|---|---|
| | | | Paper + | 10 gsm Pigment/ |
| | | | 8 micron | Starch/Binder + |
| | Test | | Metallised | 8 micron |
| Property | method | Units | OPP | Metallised OPP |
| Grammage | ISO 536 | g/m² | 80.6-82.2 | 87.9-95.7 |
| Thickness | ISO 534 | micron | 85.1 | 83.6 |

TABLE 3
Oxygen transmission rates of barrier film and paper structures

| | OTR | | |
|---|---|---|---|
| | Set 1 | | |
| | (average of 6) | Set 2 | Set 2 |
| Barrier property | | | |
| Testing Conditions | 50% RH @ | 50% RH @ | 75% RH @ |
| | 23° C. | 23° C. | 23° C. |
| Test method | DIN 53380-3 | DIN 53380-3 | DIN 53380-3 |
| Units | cm³/m²/day | | |
| Materials | | | |
| 8 micron Metallised OPP | 22.22-25.98 | n/a | n/a |
| 70 gsm Paper + 8 micron | 8.68-12.70 | 23.88-33.34 | 13.0-16.9 |
| Metallised OPP | | | |
| 65 gsm Paper + 10 gsm | n/a | 8.44-12.18 | 17.7-18.3 |
| Pigment/Starch/Binder + | | | |
| 8 micron Metallised OPP | | | |

TABLE 4
Water vapour transmission rates of barrier film and paper structures

| | WVTR | | |
|---|---|---|---|
| | Set 1 | Set 2 | Set 3 |
| Barrier property | | | |
| Testing Conditions | 90% RH @ | 85% RH @ | 85% RH @ |
| | 37.8° C. | 23° C. | 23° C. |
| Test method | ASTM F1249 | DIN 53122-1 | DIN 53122-1 |
| Units | g/m²/day | | |
| Materials | 0.19-0.23 | n/a | <1.0 |
| 8 micron Metallised OPP | | | |
| 70 gsm MFBK Paper + 8 | 0.31-0.35 | 0.06-0.07 | <1.0 |
| micron Metallised OPP | | | |
| 65 gsm MFBK Paper + | n/a | 0.07-0.10 | <1.0 |
| 10 gsm | | | |
| Pigment/Starch/Binder + 8 | | | |
| micron Metallised OPP | | | |

TABLE 5
Mineral oil migration test results of barrier paper structures

| | MOSH/MOAH |
|---|---|
| Barrier property | |
| Testing Conditions | 10 days, 40° C., Tenax |
| Test method | DIN EN 14338 |
| Units | mg/kg of food |
| Materials | |
| 70 gsm MFBK Paper + 8 | 0.6 |
| micron Metallised OPP | |
| 65 gsm MFBK Paper + 10 gsm | 0.1 |
| Pigment/Starch/Binder + 8 | |
| micron Metallised OPP | |

TABLE 6
Water Vapour Transmission Rate testing of Examples 1 and 2 at different conditions

| | | WVTR as per ASTM OFFICIAL METHOD F1249-13 | | |
|---|---|---|---|---|
| Humidity/Temperature | Units | 65% RH, 22° C. | 75% RH, 25° C. | 90% RH, 38° C. |
| Example 1 | g/m²/day | 0.0352 | 0.0470 | 0.3286 |
| Example 2 | g/m²/day | 0.0730 | 0.0666 | 0.0062 |

1. A multi-layer flexible packaging material comprising the following layers from the outer surface to the inner surface:
a paper layer with a grammage of from 40 to 120 g/m2,
an optional hydrophilic layer with a grammage of at least 1.5 g/m2,
a barrier layer comprising a material selected from the group consisting of metallized material, aluminium oxide, silicon oxide and mixtures thereof with a thickness from 20 to 300 nm, and
a polymeric layer with a grammage of from 1.0 to 15.0 g/m2,
the polymeric layer comprises at least one plastic polymer.

2. A multi-layer flexible packaging material in accordance with claim 1, wherein the barrier layer is metallised aluminium.

3. A multi-layer flexible packaging material in accordance with claim 1, wherein the polymeric layer comprises a polyolefin or polyester.

4. A multi-layer flexible packaging material in accordance with claim 1, wherein the polymeric layer comprises a polymer selected from the group consisting of polyethylene, polypropylene, polyethylene terephthalate, polyhydroxyalkanoates, polylactic acid and copolymers thereof and mixtures thereof.

5. A multi-layer flexible packaging material in accordance with claim 1, wherein the polymeric layer is oriented.

6. A multi-layer flexible packaging material in accordance with claim 1, wherein the paper layer has a grammage of from 50 to 90 g/m2.

7. A multi-layer flexible packaging material in accordance with claim 1, wherein the hydrophilic layer is present and comprises a material selected from the group consisting of starch, pigment(s) and binder or a mixture thereof.

8. A multi-layer flexible packaging material in accordance with claim 1, wherein the grammage of the polymeric layer is from 1.5 to 8.0 g/m2.

9. A multi-layer flexible packaging material in accordance with claim 1, further comprising a lamination adhesive layer between the paper layer and barrier layer.

10. A multi-layer flexible packaging material in accordance with claim 1, wherein the barrier layer has a thickness of from 30 to 200 nm.

11. A multi-layer flexible packaging material in accordance with claim 1, wherein
the paper layer has a grammage of from 60 to 100 g/m2,
the hydrophilic layer has a grammage of from 1.5 to 10.0 g/m2.
the barrier layer comprises a metallized material, and
the polymeric layer has a grammage of from 1.0 to 8.0 g/m2 .

12. A multi-layer flexible packaging material in accordance with claim 1, wherein the barrier layer is supplied by physical vapour deposition.

13. A multi-layer flexible packaging material in accordance with claim 1, wherein the plastic polymer is treated to increase the surface energy.

14. A multi-layer flexible packaging material in accordance with claim 1, wherein the material further comprises a cold or heat seal on the inner surface of the material.

15. (canceled)

16. A dry food product packaged in the multi-layer flexible packaging material comprising the following layers from the outer surface to the inner surface:
a paper layer with a grammage of from 40 to 120 g/m2,
an optional hydrophilic layer with a grammage of at least 1.5 g/m2.
a barrier layer comprising a material selected from the group consisting of metallized material, aluminium oxide, silicon oxide and mixtures thereof with a thickness from 20 to 300 nm, and
a polymeric layer with a grammage of from 1.0 to 15.0 g/m2,
the polymeric layer comprises at least one plastic polymer.

17. (canceled)
